(19) United States
(12) Patent Application Publication
(10) Pub. No.: US 2009/0029026 A1
(43) Pub. Date: Jan. 29, 2009

(54) Lightweight packaging system

(76) Inventors: Alan D. McClure, Harrison, TN (US); John McGill, Harrison, TN (US)

Correspondence Address: Alan D. McClure, Ph.D., 6615 Woody Cove Lane, Harrison, TN, 37341, US

(21) Appl. No.: 11/800,507

(22) Filed: Jul. 26, 2007

(51) Int. Cl. C12G 3/00; A23L 2/40

(52) U.S. Cl. 426/591; 426/590

(57) ABSTRACT

This invention relates to a unique lightweight packaging system for an effervescing carbonated alcoholic beverage and a method, which allows for instantaneous cooling, below ambient air conditions with carbonation of an alcoholic beverage while hiking.

This invention describes a unique lightweight nested packaging system for an effervescing carbonated alcoholic beverage and a method, which allows for instantaneous cooling, below ambient air conditions with carbonation of an alcoholic beverage while hiking. This invention utilizes a unique lightweight nested packaging arrangement to minimize the overall package weight, package size and the weight of waste materials (trash), and also allows for a method of instantaneous cooling for an effervescing carbonated alcoholic beverage while hiking on trails with water sources, consisting of an effervescing tablet, a concentrated alcohol contained in either a tablet or liquid stick pouch form, and environmentally friendly packaging components which nest together for minimizing both space and weight. We claim the present invention creates a unique nested lightweight package system, which allows hikers to carry carbonated alcoholic beverages on trails for overnight hikes. This is accomplished through a nested packaging arrangement consisting of: 1.) An effervescing tablet, 2.) A concentrated alcohol in a tablet or liquid stick pouch, and 3.) a reusable fourteen to twenty ounce (14-20 oz) lightweight capped plastic or “Nalgene” bottle into which the prior materials are nested.

The packaging arrangement herein described allows for up to a 95% reduction in weight for a six-pack of carbonated alcoholic beverages, and up to a 99% reduction in the weight of trash generated for the same. Another benefit of the invention is the reduction of the overall packaging material displacement which fit into the hikers backpack; with there being a 79% overall reduction in required backpack space.

We claim this invention provides a method of instantaneous cooling for an effervescing carbonated alcoholic beverage from natural or chilled water sources. We claim this invention reduces the overall size, by volume, of finished carbonated alcoholic beverage materials, which fit into the hikers backpack when compared to present methods. We claim this invention reduces the weight of packaging materials (trash) created when the present invention is consumed by a hiker when compared to present methods. We claim this invention reduces the carrying weight of finished carbonated alcoholic beverage products to be consumed by utilizing a concentrated alcohol packaged in tablet or a stick pouch when compared to present methods.

A compact disc accompanied the original application; it is not necessary for the application and should be discarded and disavowed. I spoke with Tyrone Johnson, at the USPTO who confirmed this statement.

### BACKGROUND OF THE INVENTION

According to recreational estimates, as found in the Joy of Hiking”, by John McKinney, there are approximately sixty-four million (64,000,000) hikers in the United States. When one takes the population data for the 2000 US Census and applies the National Institute on Alcohol Abuse and Alcoholism estimates that roughly fifty percent (50%) of the two hundred and eighty-one million (281,000,000) people in the US consume alcoholic beverages, there should be a relative equivalent estimated to be thirty-two million (32,000,000) hikers who consume alcoholic beverages. Most overnight and long distance hikers do not carry carbonated alcoholic beverages because of the weight and size of a typical can or bottle of carbonated alcoholic beverage. The “Hiker's Creed” demands that what is packed in, must be packed out, so that waste materials minimization is critical to the success of the invention for all practical extent; no one desires to carry excess trash because of the additional weight and room required inside a hiker's pack. The packaging arrangement herein described allows for up to a 95% reduction in weight for a six-pack of carbonated alcoholic beverages, and up to a 99% reduction in the weight of trash generated for the same. Another benefit of the invention is the reduction of the overall packaging material displacement which fit into the hikers backpack; with there being a 79% overall reduction in required backpack space.

Additionally, carbonated alcoholic beverages transported in hiking packs quickly heat to ambient air temperatures; this invention utilizes a method which instantaneously cools the carbonated alcoholic beverage, below ambient air conditions, except in near freezing conditions. Additionally, colder temperature liquids maintain a higher carbon dioxide level from the effervescing tablets, making it more palatable.

In the U.S. the common size of “shot” or individual alcoholic beverage sold is a fifty milliliters (50 ml) volume packaged in hardened plastic or glass. The present invention utilizes a novel approach with a concentrated alcohol packaged in a lightweight “stick pouch” with a volume of only ten to twenty milliliters (10-20 ml), thereby allowing water supplied by a trail source to be added on the trail by the hiker to achieve the optimum alcohol concentration of between six to fourteen (6-14) proof or three to seven percent (3-7%) ethanol.

The manufacturing of pouches for liquids (known as “Stick Pouches”) is a known art. In U.S. Pat. No. 7,143,910 (2006) Redmond provides a method for a pouch style containment and dispensing package for flowable products.

In U.S. Pat. No. 6,966,166 (2005) Kissling describes a high-speed “Form-Fill-Seal” machine for these “Stick Pouches”. The manufacture of stick pouches for flowable powders and liquids is commonplace in today's marketplace with many condiments such as mustard, ketchup, honey and soy sauce currently being packaged.

A typical single alcoholic beverage is twelve ounces (12 oz.) or three hundred fifty five milliliters (355 ml). By utilizing a reusable capped fourteen-ounce (14 oz) lightweight plastic or “Nalgene” bottle or similar container for the method of mixing the alcohol and the water from the trail source, a sufficient headspace is provided which allows for proper carbonation of the beverage from the effervescing tablet. Higher carbonation levels are achieved by using a closed system with lower overall temperatures.

Processes for creating an effervescing tablet are well known in the art. For instance, Kennedy, in U.S. Pat. No. 3,966,994 (1976) describes a dry beverage mix and process for preparing it, which contains phosphoric acid in a dry, stable form. The dry beverage mixes dissolve in an aqueous solution which may be carbonated to form colas, root beers, sarsaparillas or any other beverage which contains phosphoric acid as a flavoring ingredient and acidulent.

A commonly assigned and co-pending patent application Ser. No. 210,997, filed Nov. 28, 1980, and now abandoned, which is a continuation of Ser. No. 083,736, filed Oct. 10, 1979 and now abandoned discloses a carbonation method involving the use of activated charcoal having carbon dioxide adsorbed thereon. The activated charcoal technique permitted the preparation of carbonated beverages under ambient temperature and pressure conditions with carbonation levels approximating carbon dioxide solubility in water (1.3 volumes at 5.degree. C., 1 atmosphere). Higher carbonation levels were achieved by using a closed system involving super-atmospheric pressure.

Finucane in U.S. Pat. No. 4,009,292 (1977) describes combining a readily soluble form of L-aspartyl-L-phenyl methyl ester (APM) with an effervescent calcium carbonate system and citric acid, when compressed into tablet form, produces an effervescent APM tablet having superior solubility and stability and is devoid of characteristic lingering sweet aftertaste.

Sass, in U.S. Pat. No. 4,093,710 (1978) discloses free flowing, rapid dissolving, effervescent granules in particular, potassium chloride granules, which are prepared by granulating an alkali metal carbonate and/or bicarbonate and active ingredient with water containing a surfactant, such as polyethylene glycol 1540, and after drying mixing with a pharmaceutically acceptable organic acid plus additives.

Wehling in U.S. Pat. No. 6,811,793 discloses an effervescent composition of a tablet that includes stevia, water-soluble binder, water-soluble lubricant, active agent, and effervescent agent.

Effervescent tablets have been made to affect the rapid dissolution of drugs and for the production of carbonate beverages. Some years ago a sweetened and flavored tablet that formed a carbonated beverage was sold under the trade name “Fizzies”. A popular antacid, Alka-Seltzer, uses effervescence to cause rapid dissolution of the active ingredients. The conditions usually employed require only that the effervescence distribute soluble components with the solution. The present invention requires only active carbonation.

1. We claim the present invention creates a unique nested lightweight package system, which allows hikers to carry carbonated alcoholic beverages on trails for overnight hikes. This is accomplished through a nested packaging arrangement consisting of: 1.) An effervescing tablet, 2.) A concentrated alcohol in a tablet or liquid stick pouch, and 3.) a reusable fourteen to twenty ounce (14-20 oz) lightweight capped plastic or “Nalgene” bottle into which the prior materials are nested.
We claim this invention provides a method of instantaneous cooling for an effervescing carbonated alcoholic beverage from naturally occurring or chilled water sources.
An object of this invention utilizes a reusable fourteen to twenty ounce (14-20 oz) lightweight capped plastic or “Nalgene” bottle or similar container for the method of mixing the alcohol and ten to sixteen ounces (10-16 oz.) of water from the trail source; sufficient head space is provided which allows for proper carbonation of the beverage from the effervescing tablet.
Another object of this invention whereby dry/powdered flavorings, colorants, preservatives and heading agents may be added to the effervescing tablet.
We claim this invention reduces the overall size, by volume, of finished carbonated alcoholic beverage materials, which fit into the hikers backpack when compared to present methods.
We claim this invention reduces the weight of packaging materials (trash) created when the present invention is consumed by a hiker when compared to present methods.
We claim this invention reduces the carrying weight of finished carbonated alcoholic beverage products to be consumed by utilizing a concentrated alcohol packaged in tablet or a stick pouch when compared to present methods.
Another object of this invention is to utilize an alcohol in the range of one hundred to two hundred (100-200) proof or fifty to one hundred percent (50-100%) ethanol.
Another object of this invention to utilize an alcohol in the range of one-tenth to one (0.1-1.0) proof or (0.05-0.5%) ethanol.
Another object of this invention to create a final carbonated alcoholic beverage with the alcohol content being from six to fourteen (6-14) proof or three to seven percent (3-7%) ethanol.
Another object of this invention to create a final carbonated alcoholic beverage with the alcohol content being from one-tenth to one (0.1-1.0) proof or five hundredths to one-half percent (0.05-0.5%) ethanol.
Another object of this invention whereby liquid flavorings, colorants, preservatives and heading agents may be added to the stick pouch.
None of the above inventions and patents, either singly or in combination, is seen to describe the instant invention as claimed.
The structures disclosed in the foregoing patents do not provide a single mechanism for reducing the size or weight of the carbonated alcoholic beverage; for reducing the trash created from consumption of the carbonated alcoholic beverage; or provide a method for instantaneous cooling of the carbonated alcoholic beverage.
